(19) United States
(12) Patent Application Publication
(10) Pub. No.: US 2004/0125612 A1
(43) Pub. Date: Jul. 1, 2004

(54) Lighting system and device for automobile wheels

(76) Inventor: John Jackson, Boynton Beach, FL (US)

Correspondence Address: David P. Lhota, Stearns Weaver Miller, et al., Suite 1900, 200 East Broward Boulevard, Fort Lauderdale, FL, 33301, US

(21) Appl. No.: 10/734,933

(22) Filed: Dec. 12, 2003

Related U.S. Application Data
(60) Provisional application No. 60/432,762, filed on Dec. 12, 2002.

(51) Int. Cl. B60Q 1/00

(52) U.S. Cl. 362/500

(57) ABSTRACT

A cosmetic lighting system designed to shine white or colored visible light through or between the spokes of automobile wheels, wherein the system comprises a light diffusion disk having an outer rim, a hub comprising a plurality of apertures in numbers and locations for receiving the vehicle's lug nuts, a plurality of spokes extending between the rim and hub, a plurality of translucent and, or transparent diffusion areas and reflective foil pieces embedded in the translucent material, structure for routing light from a light source to the inside of the wheels and filters for protecting the light routing structure and coloring light emitted from the light source.

### CROSS REFERENCE TO RELATED APPLICATIONS

This application claims the benefit of provisional patent application Serial No. 60/432,762 filed Dec. 12, 2002.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to an automobile light system, and more particularly, to a cosmetic lighting system or disk for the wheels of automobiles and trucks wherein the lights may be clear or colored, bright or dim, constant in intensity or modulated.

2. Description of the Background Art

Automobile enthusiasts are always interested in new devices to highlight, enhance and decorate the look of their automobiles. For instance, lights are often used to illuminate the underside of automobiles and license plates. However, there are no known devices or systems that reliably light the wheels of automobiles. If a device existed for enhancing the appearance of a vehicle by lighting the wheels, it would be well received. The instant invention addresses this unfulfilled need in the prior art by providing a lighting system as disclosed herein.

### BRIEF SUMMARY OF THE INVENTION

In light of the foregoing, it is an object of the present invention to provide a light system for lighting the wheels of automobiles.

It is another object of the instant invention to provide a light system for automobiles that can emit white and, or colored light.

It is also an object of the instant invention to provide a light system for automobiles that may be manually, electronically or automatically controlled.

It is an additional object of the instant invention to provide a light system for automobiles that can be triggered by sound.

It is a further object of the instant invention to provide a light system for automobiles that is cost-effective and convenient to use.

In light of these and other objects, the instant invention provides a cosmetic lighting system designed to shine white or colored visible light through or between the spokes of automobile wheels. The invention enhances the appearance of the vehicle by emitting cosmetic lighting on and through the wheels to provide a new fad for automobile enthusiast to enhance the appearance of their vehicle. The light system generally comprises a light diffusion disk having an outer rim, a hub comprising a plurality of apertures in numbers and locations for receiving the vehicle's lug nuts, a plurality of spokes extending between the rim and hub, a plurality of translucent and, or transparent diffusion areas and reflective foil pieces embedded in the translucent material, and structure for routing light from a light source to the inside of the wheels. The light routing structure preferably comprises conduit but may also comprise fiber optic lines. A lens, window or filter is positioned in or near the open ends of the light router. The light source may comprise a lamp or LED and/or multiple colored lamps or LED's.

### BRIEF DESCRIPTION OF THE SEVERAL VIEWS OF THE DRAWINGS

FIG. 1 is a front elevational view of the preferred embodiment of the light system in accordance with the instant invention.

FIG. 2 is a front elevational view of the preferred embodiment of the light system in accordance with the instant invention illustration disks with transparent or colored diffusion sections.

FIG. 3 is an elevational view of the preferred embodiment of the instant invention illustrating the wheel fitted with the invention and mounted on a car.

FIG. 4 shows elevational views of the pipes, light sources, filters and alternative embodiments of the instant invention.

FIG. 5 is a light flow diagram of the preferred embodiment of the instant invention.

### DETAILED DESCRIPTION OF THE INVENTION

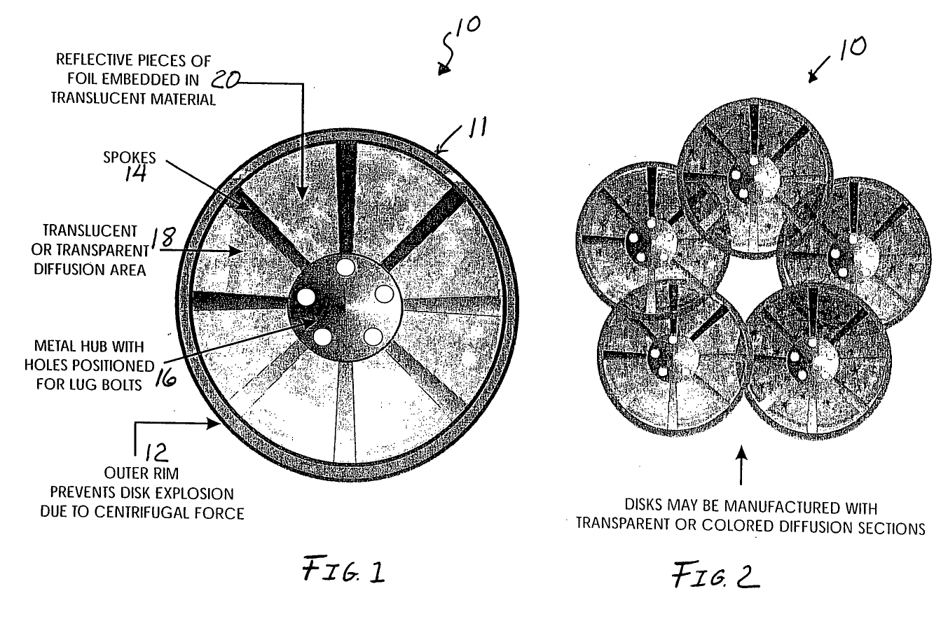

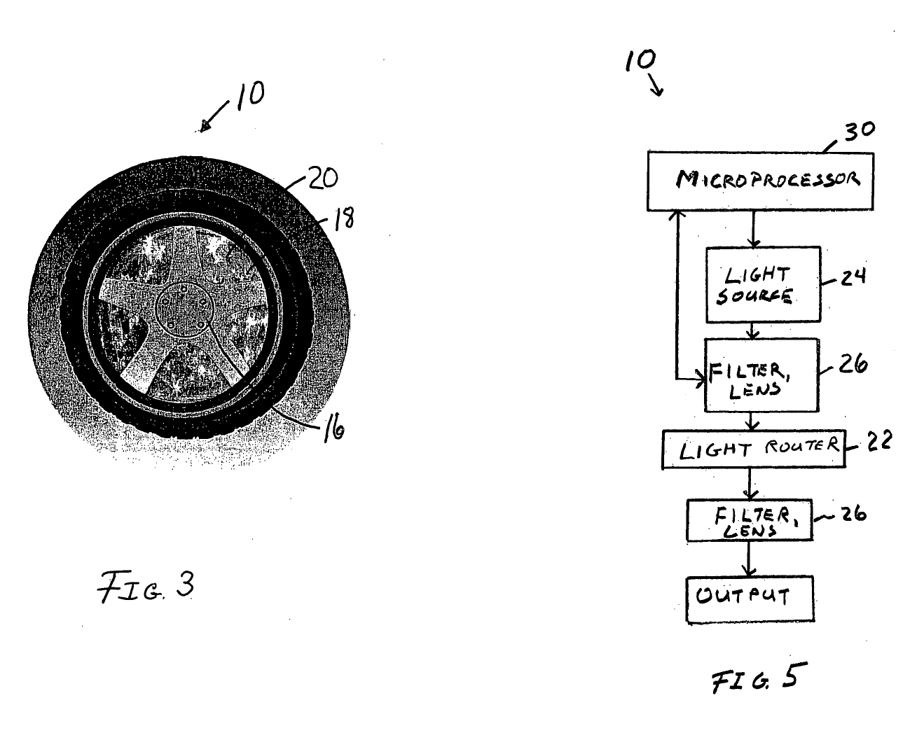

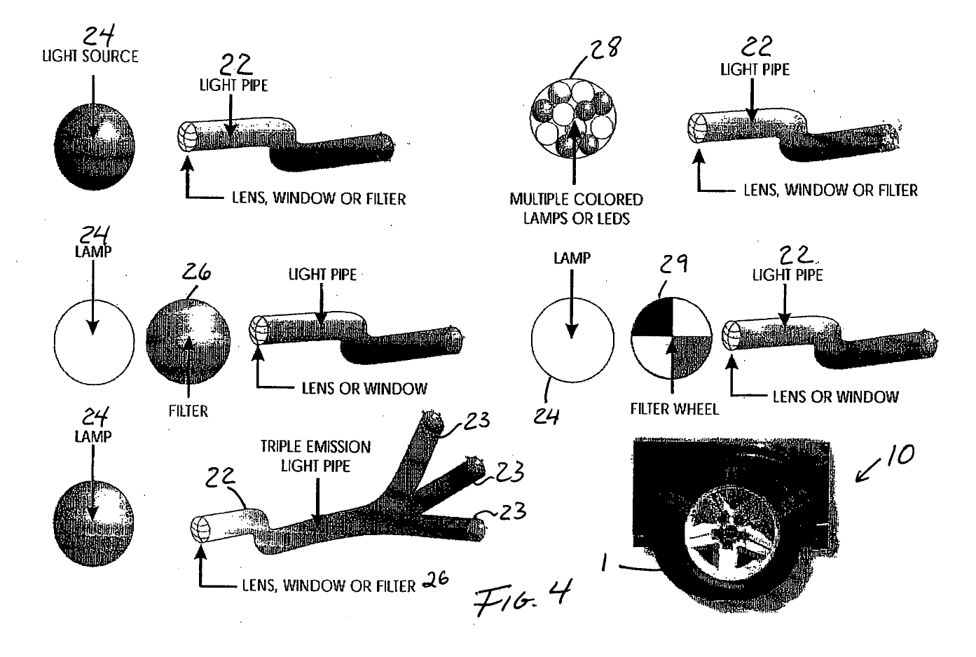

With reference to the drawings, FIGS. 1 to 5 depict the preferred and alternative embodiments of the instant invention which is generally referenced as a light system and, or by numeric character 10. The instant invention 10 provides a cosmetic lighting system for the wheels of automobiles and trucks. The light system 10 is designed to shine white or colored visible light through or between the spokes 14 of vehicle wheels. The invention 10 enhances the appearance of the vehicle by displaying cosmetic lighting on the wheels. Accordingly, it may provide a new fad for automobile enthusiast, teenagers and young adults, as they enhance the appearance of their vehicle.

With reference to FIG. 1, the light system 10 generally comprises a light diffusion disk 11 having an outer rim 12, hub 16 having a plurality of apertures in numbers and locations for receiving the lug nuts on a vehicle, plurality of spokes extending between the rim 12 and hub 16, plurality of translucent and, or transparent diffusion areas 18, reflective foil pieces 20 embedded in the translucent material 18 and structure for routing light from a light source 24 to the inside of the wheels 1. The light routing structure, referenced herein as light router(s) 22, preferably comprises conduit or pipe 22, but may also comprise fiber optic lines. The light router 22 may include a lens, window or filter 26 in, on or near an open end, individually and collectively referenced herein as a filter or filters 26. The light source 24 comprises a lamp or LED and/or multiple colored lamps or LED's 28.

The light system 10 is mounted in or on a vehicle and shines the light onto and through the area of the wheels 1. The lighting system 10 is secured in mounts that isolate the shock and vibration of the suspension to prevent damage to the light source 24 and other components. The light generated by the light source 24 is routed to the inside of the wheels 1 through the light router 22. The light router 22 has transparent or translucent material, in at least one region, with a high index of refraction and clad in an opaque material. The light router 22 directs the light into one end of the router 22 and out the other end. The light routers 22 may comprise a plurality of emission legs 23. A lens, filter or window 26, generally referenced as filter 26, is placed at each end of the light router(s) 22 to prevent damage, clouding and contamination of the light-transmitting medium. This termination lens 26 may color the light exiting the light router 22 for enhanced effects.

The light emanating from the light source 24 may have constant or variable. The light intensity may be adjusted either by manual control, electronically and, or automatically. Light options and adjustments may be pre-programmed into a microprocessor or it may be electronically adjusted in response to an audible input. Accordingly, the light system 10 may include a microprocessor 30, as shown in the light flow diagram in FIG. 5. Such a system will allow certain frequency bands to change the color of the light impinging on the wheels 1 or to vary the intensity of the emitted light with the sound level of music.

Each wheel 1 is preferably fitted with the light diffusion disks 11. The apertures of the hub 16 receive the vehicles lug bolts so that the diffusion disk 11 is mounted between the brake drum or disk and the spoked wheel. The disk 11 is fitted with spoke-like transparent or translucent light diffusion areas 18 that act to spread incident light through the entire area between the wheel spokes 14. These transparent or translucent light diffusion areas 18 may be clear or colored and may be made with internal pieces of reflective material 20 to enhance the scattering of the incident light. These reflective material pieces 20 may be made with microscopic grooves designed to act as optical gratings and cause diffraction of incident light into various colors.

The diffusion disk 11 is made with a metal hub 16 to dissipate the heat generated during braking. The diffusion disk 11 is also made with metal spokes 14 and an outer rim 12 designed to hold the disk 11 together and prevent it from flying apart due to centrifugal force as the disk 11 rotates while the vehicle is driven. The spoke-like transparent or translucent light diffusion areas 18 that act to spread incident light may be identical or different colors.

The light diffusion disk system 11 comprises a light source 24, method of directing this light to the inward side of an automotive wheel 22 and diffusing disk to allow light striking the disk to “glow” and render this diffused light visible through the spokes of a wheel 1 at a distance away from the vehicle. The light source 24 may produce white or colored light. A filter 26 may be placed at either end or both ends of the light router 22. One or more colored filters, lenses or windows 26 may be placed adjacent to the light source 24 to produce various light colors. The clear or colored light is directed to the desired area of the wheel 1 by the light router(s) 22, which has clad transparent material with a high index of refraction. The light may be directed to the desired area of the wheel 1 by means of a system of mirrors or reflective surfaces mounted in a hollow tube, such as 22, or on, in or near the diffusion disk system 11. The filter 26 is placed at the ends of the hollow tube to also prevent dirt and oils from deteriorating the reflective surfaces. The diffusion disk 11 is mounted between the brake drum or disk and the spokes using the lug bolts.

The diffusion disk 11 is made with a central hub 16 of thin metal having a series of metallic spokes 14 and a metallic rim 12 for support of transparent or translucent glass or plastic diffusion areas 18. The diffusion disk 11 may have finned sections on the metallic “spokes” for increased cooling. The transparent or translucent glass or plastic diffusion areas 18 may have internal pieces of reflective material 20 to cause a “sparkle” effect when light is shined onto the inward side of the disk 11. The internal reflective pieces 20 may be made with microscopic grooves in the surface designed to act as optical gratings to cause diffraction of incident light into various colors. The effect would be to take an incident beam of “white” light and to cause its colored components to be dispersed into various directions that would be visible between the spokes of a wheel 1. The intensity of the light source 24 may be constant or variable. The intensity of the light source 24 may be controlled either manually or electronically. The intensity of the light source may be electronically controlled using music with response made to the loudness or to certain frequencies. The color of the light source may be electronically controlled using music with response made to the loudness or to certain frequencies.

The light diffusion system 10 may be manufactured with one or more light sources or filters 26 to produce different color light directed onto the inside area of the wheels. These lights 24 may be mechanically fixed and controlled to produce varying color or intensity light. Filters 26 may be located adjacent to lamps and positioned to create a light of a chosen color. A wheel or cylinder composed of attached filters 26 may be placed near a light source such that the light emanating from a lamp is passed through the filter producing a variable color light.

The light source 24 of the lighting system 10 may be constant or of variable intensity with the light being produced by lamps 24 containing incandescent filaments, gas plasma, solid state light emitting diodes (LED's) or electro luminescent light emitters. The variable intensity of the light source 24 may be manually controlled or it may be modulated by sound. Modulation may be with sound volume or with the frequency of sounds.

Light from the light source 24 may be directed to the inside of the wheels 1 or some other desired position using the light router(s) 22. The light may also be reflected using a system of mirrors or mirrored surfaces mounted inside the light router 22 onto the area inside of the wheels. The light router 22 should be capped on each end with a lens, filter or window 26 to prevent dirt and oil from degrading the reflective surfaces.

The diffusion disk 11 may contain colorless or colored sections of spoke-like transparent or translucent light diffusion areas 18. These areas are designed to spread incident light through the entire area between the wheel spokes to give a lighted cosmetic effect. These areas are also designed to cause sections of the wheel not directly illuminated to “glow” and appear illuminated in order that light may be visible from the outward side of the wheel.

The light system 10 preferably uses a high intensity light source with quartz halogen lamps being the cheapest and most intense source. Other lighting sources are described in the previous sections and may be used to provide a specific color or effect. The filter system 26 may be made from transparent or translucent glass or plastic sections. Acrylic (polymethyl methacrylate) plastic is the preferred plastic material to construct the filter 26.

The light router 22 as a cylinder is preferably constructed of transparent plastic having a high index of refraction. The entire router 22, or selected sections thereof, may be translucent or transparent. The router 22 is preferably clad with an outer shield of protective plastic or metal. The preferred plastic material to construct the cylinder version of the light router 22 is acrylic (polymethyl methacrylate) plastic. The filters 26 may comprise glass or plastic lenses, windows or filters.

The diffusion disk 11 is made with a central hub 16 of thin aluminum, magnesium or steel sheet having a series of metallic spokes 14 and a metallic rim 12 for support of the transparent or translucent glass or plastic diffusion areas 18. The disk 11 may have finned sections of the metallic spokes for increased cooling.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A light system for illuminating at least one vehicle wheel, said light system comprising:
a light diffusion disk comprising at least one translucent area and at least one reflective surface, said light diffusion disk being mountable proximal the wheel;
a light source for facilitating the receipt of light by said light system; and
means, in optical communication with said light source and said light diffusion disk, for routing the light produced by said light source and directing it toward said light diffusion disk.

2. A light source as recited in claim 1, wherein said diffusion disk further comprises:
a hub comprising a plurality of apertures in numbers and locations for receiving lug nuts that secure the wheel to the vehicle.

3. A light system as recited in claim 2, wherein said diffusion disk further comprises:
a rim; and
a plurality of spokes extending from said hub to said rim and defining a plurality of said translucent areas, said reflective surfaces being imbedded in said translucent areas.

4. A light system as recited in claim 1, further comprising:
a filter disposed over at least one end of said light routing means to block out foreign objects that could contaminate or cloud said light routing means.

5. A light system as recited in claim 4, wherein said filter comprises:
at least one colored filter to produce colored light.

6. A light system as recited in claim 4, wherein said filter comprises:
a plurality of colored filters to produce a plurality of different colored light.

7. A light system as recited in claim 1, wherein said light routing means comprises:
at least one hollow light-transmitting medium having a first end and a second end.

8. A light system as recited in claim 7, further comprising:
means, disposed over at least one said end of said hollow light transmitting medium, for blocking out foreign objects that could contaminate or cloud said light routing means.

9. A light system as recited in claim 8, wherein said blocking means comprises:
at least one filter, said at least one filter comprising at least one colored filter to color the light from said light source.

10. A light system as recited in claim 8, wherein said filter comprises:
a plurality of colored filters to color the light from said light source in a plurality of different colors.

11. A light system as recited in claim 1, wherein said hollow light transmitting medium comprises:
at least one pipe.

12. A light system as recited in claim 1, wherein said hollow light transmitting medium comprises:
at least one fiber optic line.

13. A light system as recited in claim 1, wherein said hollow light transmitting medium comprises:
a plurality of pipes.

14. A light system as recited in claim 1, wherein said light source produces light in at least one color.

15. A light system as recited in claim 1, further comprising:
means for securing said light system to a vehicle and for isolating shock and vibration to prevent damage to said light source, said securing means comprising means for mounting said diffusion disk between a vehicle's brake and wheel.

16. A light system as recited in claim 1, wherein said translucent area comprises:
at least one color for coloring the light from said light source.

17. A light system as recited in claim 1, wherein said reflective material comprises:
at one groove that acts as an optical grating to cause the diffraction of incident light.

18. A light system as recited in claim 1, wherein said spokes comprise fins and said hub comprises metal to dissipate heat.

19. A light system as recited in claim 1, further comprising:
means for controlling the intensity of the light.

20. A light system as recited in claim 19, wherein said light intensity controlling means comprises:
a microprocessor in electrical communication with said light source and, or said filter.
